(19) United States
(12) Patent Application Publication
(10) Pub. No.: US 2002/0135470 A1
(43) Pub. Date: Sep. 26, 2002

(54) Safety motion detector for vehicles

(76) Inventor: Jason Patrick Campagna, Chalmette, LA (US)

Correspondence Address: Jason Patrick Campagna, 2007 Corinne Drive, Chalmette, LA, 70043, US

(21) Appl. No.: 10/104,741

(22) Filed: Mar. 21, 2002

Related U.S. Application Data
(60) Provisional application No. 60/278,351, filed on Mar. 26, 2001.

(51) Int. Cl. B60Q 1/00

(52) U.S. Cl. 340/436; 340/435; 340/901; 340/903

(57) ABSTRACT

A device for monitoring and signaling trailing vehicles as they approach a safe proximity barrier to breaching that particular safe barrier. Once this barrier is breached, a signal unlike any other light signal found presently on vehicles will notify the trailing driver of their actions (i.e. tailgating). This light signal acts with the brake, reverse, hazard, and signal lights. The system is designed not interfere with such above-mentioned devices. With this in mind, the inventive device is non-confusing, globally understable, and easily recognizable non-confusing, globally understandable and easily recognizable way.

### BACKGROUND

1. Field of Invention

This invention relates to a rear safety device and signaling system, more particularly pertaining to a new method of signaling trailing vehicles and the like in a non confusing, globally understandable and easily recognizable way.

2. Description of Prior Art

Vehicular accidents have been around ever since their production. The technological movement has been to make vehicles safer both on the inside and on the outside. Improvements made in vehicular technology seem to improve yearly. Most notably advancements in technology have been in the areas of seat belts, anti-lock breaks and air bags both frontal and side.

It is understood that the number of vehicles entering our local and interstate highway systems have been ever increasing. A direct result of this is the increase time wasted in traffic congestion. Vehicular technology cannot make a driver's performance improve. The above-mentioned invented technologies assist drivers in their daily lives many of the times without driver intervention or attention. Technology serves as the automatic bridge driver's utilize on a daily basis. Technological information is what drivers need in order to be safe on today's roadways.

One of the most common accidents today involves rear end collisions. This type of accident is commonly referred to as a “tailgating” accident. The reason behind this adjective is that the trailing vehicle is following too close behind the forward vehicle and once the forward vehicle reduces momentum and or stops, a collision occurs because there is not enough time nor space for the trailing vehicle to stop in. This problem is exacerbated if confusion on the trailing driver's part is present.

Commonly, there are two ways to deter a trailing vehicle from following too closely; tap on the brake pedals and slowing down. Tapping on the brake pedals will get the attention of the trailing driver but quite possibly in the process of warning the trailing driver, the actions of the forward driver will cause an accident. Slowing down to allow the trailing driver to pass may increase the likelihood of road rage and or an accident. These actions and reactions may very well occur and has occurred across the country.

The problem, how do we monitor and then signal a trailing vehicle driver's that their actions (i.e. tailgating) is unsafe? How then do we signal the problem in a non confusing, globally understandable and easily recognizable way, which is non intimidating to the trailing driver and automatic, unknown to the forward driver?

The present invention relates to a rear safety device and system for use in motorized vehicles.

The inventive system monitors the rear area of the vehicle and alerts both the trailing driver and possibly the lead vehicle's driver of the current hazardous situation.

The essence of this invention involves installing a motion detector (motion proximity sensor) in the center rear (most appropriate given the nature of the device) of the vehicle above the middle brake light, for example, or any reasonable spot on the rear of the vehicle. This device can be installed on any motorized vehicle. The device can be of any shape or size to be customized to the uniqueness of the vehicle. If another vehicle moves in too closely to the car from behind and for a certain amount of time (i.e., tailgating), the motion detector will automatically activate a pair of different colored lights. These other colored lights will differ from those associated with the color of the brake lights (red), turning signal/hazard lights (yellow), and reverse lights (white). There are no specific colors that will be implemented, however, to create a distinction from the established colors (red, yellow, and white respectively) the lights would be of a different color than those mentioned (red, yellow, and white). This color differentiation should be utilized to minimize possible confusion. This device will give a visual signal that would be interpreted by the approaching driver that he or she is too close to the lead vehicle. Furthermore, this light signal will have either a different ‘rhythmic beat’ to the pulses of light from those presently found within various turning signal lights or remain lighted during the duration of breaching activity. As for the ‘rhythmic beat’ function, there are no specifics given to this device concerning this ‘beat’ due to the possible variations the various vehicle manufacturers and or government regulations warrant. Government regulations may warrant that only the hazard and turning lights are appropriate for a ‘rhythmic beat’. Therefore, the signaling device may have to have a constant signaling light (i.e. activated for the duration of the tailgating episode then off once the proximity is clear) instead of a ‘rhythmic beat’ signaling light. The placement of this visual signal will obviously be towards the rear of the exterior, interior or both of the lead vehicles. It is the vision of the inventor to have either the visual signal light incorporated in the present braking light systems (i.e. the brake/turning/hazard light cluster) or in the form of a stand-alone signal light, built in to the rear exterior, interior or both of the lead vehicle. There are no specifics for this placement other than on the two above-mentioned positions. These placement positions are not to be considered as limiting factors. They are to be considered by the reviewer(s) as points of information and possible placement areas to help facilitate the understanding of the nature of the invention. Regardless of the light signal's placement, the essence is a proximity sensor connected to a varied colored light other than the colors of light currently found on the rear of vehicles. Continuing, the light signal is to be used to give visual warning to the approaching drivers that their proximity given the lead vehicle and the space between the two is unsafe (i.e. tailgating). If the proximity is breached, the signal light will be activated on the lead vehicle.

Another benefit of this device is that it is designed for those approaching drivers who cannot read and or may not understand the English language. With this in mind, world-wide application and utilization of this device is apparent. Furthermore, a device that conveys a message through a colored light signal is more powerful and better understandable than a ‘worded’ signal. This visual signal does nothing to affect the performance of the lead vehicle. It has been determined that devices attached to the braking system and or brakes lights may lead to increase in the number of accidents. This signaling/alerting device indicates to the approaching vehicle to increase the distance between the lead and trailing vehicles, due to the fact that the ‘safe’ proximity has been breached.

The utilization of tailgating monitoring devices for vehicles is known in the prior art. The vast majority of the prior art lends itself to monitor and deter rear vehicles from tailgating through the utilization of words, brake lights, and other lighting sources. Furthermore, the informing mediums add confusion, misunderstanding, and distrust. While these informing devices have the sole purpose of monitoring and informing, they certainly would not be a good choice to serve as an easily understood monitoring and informing safety device.

The use of monitoring and informing devices utilized by leading vehicles to monitor trailing vehicles is known in the prior art. However, the referenced prior art deals with a lighted sign, which activates when a lead vehicle detects a trailing vehicle. This presents a concern because everyone does not understand English. Furthermore, there are many individuals that cannot read. U.S. Pat. No. 5,838,228 by Clark, U.S. Pat. No. 6,177,866 by O'Connell, U.S. Pat. No. 6,178,677, by Williams, U.S. Pat. No. 6,133,851 by Johnson.

The use of monitoring and informing devices utilized by leading vehicles to monitor trailing vehicles is known in the prior art. However, the referenced prior art deals with the gas pedal being manipulated. This presents a concern because if an alarm of some kind is set to monitor a gas pedal, false alarms could trigger a negative response from the driver of the lead vehicle possibly causing an accident if the driver was not expecting such a response. A false alarm in the inventive device would not trigger a negative response but merely more information to the trailing driver. U.S. Pat. No. 6,119,068 by Kannonji.

The use of monitoring and informing devices utilized by leading vehicles to monitor trailing vehicles is known in the prior art. However, the referenced prior art deals with simply avoiding collisions through varying light rates automatically. This presents a concern because if a trailing vehicle changes lanes and happens to cross the zone of signal actuation, a fast flash rate of light will bombard the trailing driver causing possible panic on the trailing driver's part possibly resulting in an accident. U.S. Pat. No. 5,162,794 by Seith.

The use of monitoring and informing devices utilized by leading vehicles to monitor trailing vehicles is known in the prior art. However, the referenced prior art deals with the advising of the trailing driver of the close proximity of the two vehicles. As mentioned previously, this presents a concern because if a trailing vehicle changes lanes and or follows too closely, brake lights will appear. This braking system could be registered by the trailing driver as a stop, causing panic on the trailing driver's part possibly resulting in an accident. U.S. Pat. No. 5,684,474 by Gilon et al, U.S. Pat. No. 5,663,706 by Fracis, U.S. Pat. No. 5,760,708 by Seith, U.S. Pat. No. 4,891,624 by Ishikawa et al.,

The use of monitoring and informing devices utilized by leading vehicles to monitor trailing vehicles is known in the prior art. However, the referenced prior art deals with the automatic detection the presence of an object in the vicinity of the vehicle. This presents a concern because the automatic and instant nature of the detection device and warning signal could be registered as a stop causing possible panic on the trailing driver's part possibly resulting in an accident. U.S. Pat. No. 4,626,850 by Chey.

The use of monitoring and informing devices utilized by leading vehicles to monitor trailing vehicles is known in the prior art. However, the referenced prior art deals with a warning before automatically making the braking force determined by the distance between two vehicles. This presents a concern because anytime a physical action (e.g. braking of the vehicle) is done automatically without human intervention; it may result in an accident especially if the lead and trailing drivers are not expecting such a response. U.S. Pat. No. 5,574,644 by Butsuen et al, U.S. Pat. No. 4,833,469 by David.

The use of monitoring and informing devices utilized by leading vehicles to monitor trailing vehicles is known in the prior art. However, the referenced prior art deals with a simple interior alarm device. This does nothing to inform the trailing driver of their dangerous situation. U.S. Pat. No. 4,694,296 by Sasaki et al.

The use of monitoring and informing devices utilized by leading vehicles to monitor trailing vehicles is known in the prior art. However, the referenced prior art deals with a flashing light of notification. This presents a concern due to the fact that the flashing lights may confuse the trailing driver possibly resulting in an accident. U.S. Pat. No. 6,154,126 by Beasley et al.

The use of monitoring and informing devices utilized by leading vehicles to monitor trailing vehicles is known in the prior art. However, the referenced prior art deals with automatic speed control. This presents a concern because anytime a physical action (e.g. reducing the vehicle's speed) is done automatically without human intervention; it may result in an accident. U.S. Pat. No. 5,166,681 by Bottesch et al.

The use of monitoring and informing devices utilized by leading vehicles to monitor trailing vehicles is known in the prior art. However, the referenced prior art deals with different signaling means from the inventive art. Furthermore, as a backup, the hazard lights are then utilized. This possibly will cause panic on the trailing driver's behalf resulting in an accident U.S. Pat. No. 3,949,3632 by Doyle, et al.

The use of monitoring and informing devices utilized by leading vehicles to monitor trailing vehicles is known in the prior art. However, the referenced prior art deals with signaling means similar to a traffic light. This presents a concern in that trailing drivers may understand a signal light; however, an adoption to a vehicle may be confusing to them. U.S. Pat. No. 5,923,243 by Bleiner.

The use of monitoring and informing devices utilized by leading vehicles to monitor trailing vehicles is known in the prior art. However, the referenced prior art deals with the detection of white lines given rear objects. This presents a concern because how can this system operate when the presence of lines are not available. U.S. Pat. No. 5,874,904 by Hirabayashi.

The use of monitoring and informing devices utilized by leading vehicles to monitor trailing vehicles is known in the prior art. However, the referenced prior art deals with detecting headlights and then signaling through the vehicles' hazard lights. This presents two concerns in that what occurs if the trailing vehicle does not have a head lights on. Furthermore, the use of the hazard lights for signaling may confuse the trailing driver possibly resulting in an accident. U.S. Pat. No. 5,663,705 by Pretorius et al.

The use of monitoring and informing devices utilized by leading vehicles to monitor trailing vehicles is known in the prior art. However, the referenced prior art deals with a monitoring device that is activated when a sensor detects the vehicle and then automatically adjusts the transmission accordingly. This presents a concern because anytime a physical action (e.g. adjusting the vehicle's transmission) is done automatically without human intervention, it may result in an accident simply because the trailing driver was not expecting such an action. U.S. Pat. No. 5,717,377 by Gao.

The use of monitoring and informing devices utilized by leading vehicles to monitor trailing vehicles is known in the prior art. However, the referenced prior art deals with the utilization of hazard lights as the means of signaling. This presents a concern due to the fact that the hazard lights/signaling lights may confuse the trailing driver possibly resulting in an accident. U.S. Pat. No. 5,914,651 by Smalls.

The use of monitoring and informing devices utilized by leading vehicles to monitor trailing vehicles is known in the prior art. However, the referenced prior art deals with vehicle-to-vehicle signaling. In other words, both vehicles must possess the device. This presents a concern due to the fact that some vehicles may not possess such of a device. U.S. Pat. No. 6,097,311 by Iwasaki et al.

The use of monitoring and informing devices utilized by leading vehicles to monitor trailing vehicles is known in the prior art. However, the referenced prior art deals with “flashback” technology. In other words, the use of strobe lights as an effective signaling means. This presents a concern due to the fact that the flashing lights may confuse the trailing driver. U.S. Pat. No. 6,025,775 by Erlandson.

The use of monitoring and informing devices utilized by leading vehicles to monitor trailing vehicles is known in the prior art. However, the referenced prior art deals with a system that warns the driver of possible hazardous conditions. Furthermore, it does not inform the trailing driver of their current possibly hazardous situation. U.S. Pat. No. 5,631,639 by Hibino, et al.

The use of monitoring and informing devices utilized by leading vehicles to monitor trailing vehicles is known in the prior art. However, the referenced prior art deals with the informing of the trailing drivers and their current situation through the use of brake lights. Furthermore, the system also uses different colored lights as well. This presents a concern due to the fact that the brake lights and or flashing lights may confuse the trailing driver. U.S. Pat. No. 4,600,913 by Caine.

While these devices satisfy their respective particular objectives, requirements and scope, the above-mentioned patents do not disclose a monitoring and signaling similar to the inventive device and the objectives, advantages, and scope disclosed in the subsequent sections. The inventive device includes a system to monitor a given proximity and then signal once that proximity has been breached. The monitoring device is a proximity-sensing device utilizing the latest in proximity sensing inventions found near the rear on the vehicle. There are no specifics as to which proximity-sensing device should be utilized. Furthermore, placement near the rear is not to be considered a limiting factor. The signaling device, which is not limited to one or a pair of different colored lights, envisioned in a brake/turning signal light cluster found on each side of the vehicle for easily recognizable and globally understood signals.

The prior art listed may be perfectly suitable for purposes, which they were designed; however, they would not be suitable for the purposes of the present invention, as hereinafter described.

### OBJECTS AND ADVANTAGES

Accordingly, the Safety Motion Detector for Vehicles described; there are various objects and advantages of the present invention:

(a) to provide enabling/disabling capabilities that will provide drivers with optional usage;

(b) to provide rear signaling different from current brake light systems and signals;

(c) to provide rear signaling different from current signal light systems and signals;

(d) to provide rear signaling different from current reverse light systems and signals;

(e) to provide rear signaling different from current hazard light systems and signals;

(f) to provide proximity based on various highway and road conditions;

(g) to provide enabling/disabling capabilities given time and or speed;

(h) to provide a warning based signal to the driver alerting him or her to the malfunction;

(i) to provide a warning based signal to the driver alerting him or her to the proximity breach.

In continuation of the objects and advantages of the present invention, the inventor wishes to further explain the above-mentioned objects and advantages.

In accordance with (a), this device will have the ability to be manually turned on/off by the driver. The ability to turn the device on/off will be through a switch or button type of device. However, the design of the device may include widely accepted switching devices not mentioned but readily understood by those who are familiar with the possible variety of switching devices known or which may become apparent and or developed in the future. There are many occurrences when a driver may want a device of this nature to be disabled for a particular activity (e.g. towing a trailer) and point in time (e.g. congested traffic conditions). These examples should not be considered as limiting factors. These examples should serve as a means to better explain the device and assist the reviewer(s) in their understanding. Furthermore, this device's enabling/disabling capacity will be administered by the device's on board computer. The device's on board computer will detect when the switching control is set to enable/disable mode. This aspect and function from research is unique.

In accordance with (b), this device will have the ability to be temporally disabled when the brakes are applied and when the corresponding brake lights are activated. This aspect eliminates the various color combinations, which may possibly distract the trailing driver and cause an increase in accidents involving both and possibly more vehicles. Furthermore, this device will be monitored and the temporally disabling function will be administered by the device's on board computer. The device's on board computer will detect when the driver of the lead vehicle applies the brakes, which corresponds to the activation of the brake lights of the lead vehicle. This function from research is unique.

In accordance with (c), this device will have the ability to be temporally disabled when the vehicle's signaling device (i.e. turning signals) are applied and when the corresponding signaling lights are activated. This aspect eliminates the various color combinations, which may possibly distract the trailing driver and cause an increase in accidents involving both and possibly more vehicles. Furthermore, this device will be monitored and the temporally disabling function will be administered by the device's on board computer. The device's on board computer will detect when the driver of the lead vehicle applies the vehicle signaling system, which corresponds to the activation of the signaling lights of the lead vehicle. This function from research is unique.

In accordance with (d), this device will have the ability to be temporally disabled when the vehicle's reverse device (i.e. reverse signals) is applied and when the corresponding reverse lights are activated. This aspect eliminates the various color combinations, which may possibly distract the trailing driver and cause an increase in accidents involving both and possibly more vehicles. Furthermore, this device will be monitored and the temporally disabling function will be administered by the device's on board computer. The device's on board computer will detect when the driver of the lead vehicle applies the vehicle reverse device system, which corresponds to the activation of the reverse lights of the lead vehicle. This function from research is unique.

In accordance with (e), this device will have the ability to be temporally disabled when the vehicle's emergency device (i.e. hazard signals) is applied and when the corresponding emergency lights are activated. This aspect eliminates the various color combinations, which may possibly distract the trailing driver and cause an increase in accidents involving both and possibly more vehicles. Furthermore, this device will be monitored and the temporally disabling function will be administered by the device's on board computer. The device's on board computer will detect when the driver of the lead vehicle applies the vehicle emergency signaling system, which corresponds to the activation of the emergency lights of the lead vehicle. This function from research is unique.

In accordance with (f), this device will have the ability to detect an ‘adequate’, ‘safe’, and or ‘minimum’ proximity, generated by a calculated formula of the lead vehicle given road (e.g. constant speed over a period of time) highway (e.g. MPH), and or interstate conditions (e.g. weather). For example, if the lead vehicle is traveling at 60 MPH a calculated ‘adequate’, ‘safe’, and or ‘minimum’ distance would be determined by an on board computer for 60 MPH. Any breach in that proximity will signal the proximity signal lights. The distances would be calculated given the various speeds of the lead vehicle or programmed with specific parameters (e.g. given ‘safe’ distance corresponding to the speed). As mentioned previously, a device that relates to the conditions of the roadway could further control the system. For example, if the interstate conditions are wet due to the occurrence of rain, the activation of the vehicle's windshield wipers would relay a message to the device's on board computer informing of the current road conditions. The device's on board computer may calculate the safe distance for the current road condition and respond accordingly. A further example, if the interstate conditions were dark due to nightfall, the activation of the vehicle's headlights would relay a message to the device's on board computer informing of the current road conditions. In a still further example, if the interstate conditions were obstructed due to fog, the activation of the vehicle's fog lights, if the vehicle were equipped with such lights, would relay a message to the device's on board computer informing of the current road conditions. These above-mentioned examples are not to be considered as limiting factors. These examples are introduced to further explain ‘safe’, ‘adequate’, and or ‘minimum’ proximity given current driving conditions. The packaging of functions along with the unique nature of the device creates a complete ‘safety’ package, which is unique.

In accordance with (g), this device will have the ability to become automatically activated above a certain speed, whether set by the driver, manufacturer, and or a combination of both. If the lead vehicle is traveling below the minimum set speed to induce the readiness of the device, the device will remain inactive given that the device is set. On the other hand, once the desired speed is attained and then surpassed, the device will become active. If the speed falls below the minimum set speed to induce the readiness of the device, the device becomes inactive until the desired minimum set speed is attained and then surpassed. This device will be monitored and the functions administered by the device's on board computer, which will detect when the driver of the lead vehicle accelerates/decelerates, above/below the minimum set speed. However, if the lead driver does not set a minimum activation speed, there would be a default setting the vehicle manufacturer could implement. It is important to note that the manufacturer can set the default speed, however, it is not limited to just the default setting. Both the Safety Motion Detector for Vehicles operates with driver options and manufacturer defaults or just with a manufacturer set speed. This should be understood, as the device will be automatically activated once the vehicle is in operation above a set minimum speed. The setting of the minimum speed will be accomplished by physically assigning data to the device's on board computer system. In other words, for the device to be activated with a set speed, the driver of the vehicle must decide on the speed. Either the driver sets the minimum speed, which can vary by the possible various speeds a driver may travel at, or the manufacturer sets the activation speed as a minimum speed. If the driver does not set a speed, the default speed, decided by the manufacturer, will be implemented. For example, if the driver sets the activation speed at 30 mph because of city driving, the system will not activate itself if speeds are below 30 mph. Continuing, if the driver sets the activation speed at 50 mph because of interstate driving, the system will not activate itself if speeds are below 50 mph. A device, which is designed to activate/deactivate based on speed, is unique based on research.

Along with the above-mentioned characteristic (g), this device will have the ability to become activated after a certain time has elapsed. In other words, the device will not become activated until a certain amount of time has elapsed while the approaching vehicle is within the given proximity. The inventor's reason for this addition is to point out that there may be times when the activity of ‘tailgating’ is accidental. An example of this, but not to be limited to, is when a lead vehicle is turning without the utilization of the vehicle's signaling system, the approaching vehicle may accidentally breach the proximity, activating the signal warning lights and possibly resulting in a dangerous situation for both vehicles. Another example of this, but also not to be limited to, is in the activity of ‘lane switching’. Continuing, an approaching vehicle may breach the proximity when moving from one lane to another. It is the purpose of the device to monitor and then warn approaching drivers of their unsafe activity. Enabling this device to automatically activate the warning/signal lights at the very instance of the proximity breach is realistic, but extremely unsafe. Furthermore, this delayed signal response is a significant benefit of this device. A minimum time requirement concerning the time given to the breaching activity is necessary to reduce the unavoidable ‘tailgating’ activities and ‘false alarms’ that may occur. It is the inventor's belief that a minimum time standard will be best determined by the vehicle manufacturer and or government regulators. A device, which is designed to possess a delayed activation aspect given breach of proximity, is unique based on research.

In accordance with (h), this device will have the ability to notify the driver of the lead vehicle if there is a malfunction with the monitoring, signaling and or device's on board computer system. There are varieties of malfunctions that can occur: sensor-range problems, time problems, and light outages just to name a few. This is not an inclusive list; however, these are some of the possible problems, which may occur. Malfunction notification could be through a variety of ways, including but not limited to, audio, visual, or a combination of the two. As mentioned above, these notification aspects are not to be considered as limiting factors. They are only mentioned here to provide answers and possibly help the reviewer(s) understanding of the of the safety system as a whole. Once the malfunction occurs, notification will be made. The time period of notification is not stated because of the endless range of time possibilities. However, sufficient time should be made to notify the driver of the malfunction so that the driver will have equally sufficient time to decide what action(s) should be done. The driver of the lead vehicle could then deactivate the system, if he or she so chooses, utilizing the on/off control. Automatic deactivation through the device's on board computer is also a possibility given the unique nature of the safety device. Any device, which malfunctions on a utilized vehicle, may cause significant problems to the vehicle and or to vehicles in the surrounding area. A device, which is designed to possess malfunction notification and then either driver or automatic manipulation to deactivate such system is unique based on research.

In accordance with (i), this device will have the ability to notify the driver of the lead vehicle when the approaching vehicle is following too closely (i.e. tailgating). This notification will be visual and or audible in nature. This visual notification could be in the form of colored light(s). The colored light(s) may be a variety of colors; there are no specifics given for this color. This notification device will be an interior and or exterior device that will keep the driver of the lead vehicle aware and informed of his or her surroundings. There are areas in and around the vehicle where the placement of the signal device will be ‘easily detectable’ by the lead driver, and out of the ‘normal vision’ of the driver. The term ‘easily detectable’ refers to the placement of the device within easy eye contact of the driver (e.g. the instrument panel, side mirrors, etc.). The term ‘normal vision’ refers to any exterior view (i.e. from the inside of the vehicle to the outside (e.g. window)). In other words, the lead driver ‘tailgating’ signaling device could be placed on the exterior granted it does not obstruct the view of the driver. For both references, these areas are not areas limited to placement. The examples given are merely to educate and inform the reviewer(s) of such placement a recommended area of placement, which is not limited by suggestion. The light(s) placement is to be determined by the variety of vehicles, which may utilize and implement the Safety Motion Detector for Vehicles. Placement will vary from vehicle to vehicle, however within vehicle types, placement should be standard. This visual interior light signal could be accompanied by audible signal(s) as well. The audible signal(s) could be in many forms (e.g. bells, voice stating warnings, beeping, etc.). These examples of audible sounds are not to be understood as limiting factors. The ability to choose among the variety of audible sounds rest solely with the inventor, device manufacture, and vehicle manufacture. The mentioning of these audible sounds represent the desire of the inventor to educate and inform the reviewer(s) of the possible but certainly not limiting audible sounds. The inventor sees both signals becoming problematic however. The inventor believes this will become distracting and over time it could prove to be annoying to the driver of the lead vehicle. With this stated, a switch could be implemented on the Safety Motion Detector for Vehicles' control panel. This control will allow on/off capabilities of signal light(s) as well as audible sound levels (i.e. control settings). As stated previously, the visual and audio warning will be easily detectable yet unobtrusive to the driver. Vehicle manufacturers have the ability, through the approval of the inventor, not to include such an option. There are instances, understood by the inventor, were both visual and audible signals may not be desired. The inclusion of this option is to give the reviewer(s) a better understanding of the ‘option rich nature’ of the invention The term ‘option rich nature’ refers to functions, which do not adversely affect the device if not implemented. A particular vehicle manufacturer may desire all of the other functions of this device except for the one in question. As stated previously, the manufacturer has the ability to disable or not include the function by getting approval from the inventor first. Continuing, there perhaps is a time and environment to have this function disabled (e.g. night driving and sleeping children). These examples given is to give the reviewer(s) a better understanding of the time and environment when the driver may choose to deactivate the notification function and not to be understood as limiting factors. If implemented, the lead driver would solely control the visual and audible warning signals, which is unique based on research.

Further objects and advantages will become apparent from a consideration of the ensuing description and drawings.

### SUMMARY OF THE PRESENT INVENTION

This invention relates to a rear safety device and signaling system, more particularly pertaining to a new method of signaling trailing vehicles and the like in a non confusing, globally understandable and easily recognizable way.

### BRIEF DESCRIPTION OF THE DRAWINGS

In order that the invention may be more fully understood, it will now be described, by way of example, with reference to the accompanying drawings in which:

FIG. 1 is an expanded view noting the various aspects and functions of the Safety Motion Detector for Vehicles.

FIG. 2 is an alternate expanded view noting the various aspects and functions of the Safety Motion Detector for Vehicles.

FIG. 3 is a back-view of a vehicle possessing four (4) possible placement areas of the proximity-sensing device as well as the tailgating signal lights.

FIG. 4 is an alternate back-view of a vehicle possessing possible placement areas of the proximity sensing device as well as the tailgating signal lights.

FIG. 5 is a vertical view of the possible brake signal light, turning signal/hazard signal lights, reverse signal lights, and tailgating signal lights.

FIG. 6 is a horizontal view of the possible brake signal light, turning signal/hazard signal lights, reverse signal lights, and tailgating signal lights.

FIG. 7 depicts a vehicle breaching the safe proximity range activating the tailgating signal lights.

FIG. 8 depicts a vehicle, which does not breach the safe proximity range not activating the tailgating signal lights.

### LIST OF REFERENCE NUMERALS

With regard to the reference numerals used, the following numbering is used throughout the various figures.

10 Safety Motion Detector for Vehicles

20 Proximity Sensor Container

30 Proximity Sensing Device

40 Wire to Ground

50 Proximity Sensing Housing

60 Wire(s) to Existing Power Supply

70 Existing Power Supply (Eye Sensor Power Source) (Informative Purposes, Represented by a Single Disposable Battery)

80 Wire(s) to On Board Computer

90 On Board Computer

100 Wire(s) to Brake Applicator

110 Brake Applicator (Informative Purposes, Represented by a Square Box with the Letter ‘A’ in the Center)

120 Wire(s) to Brake Lights

130 Brake Lights (Informative Purposes, Represented by a Single Light Bulb)

140 Wire(s) to Turn Signal Applicator (Separate for Illustration Purposes from the Hazard Signal Applicator)

150 Turn Signal Applicator (Informative Purposes, Represented by a Square Box with the Letter ‘A’ in the Center) (Separate for Illustration Purposes from the Hazard Signal Applicator)

160 Wire(s) to Turn Signal Lights (Separate for Illustration Purposes from the Wire's to Hazard Signal Lights)

170 Turn Signal Lights (Informative Purposes, Represented by a Single Light Bulb) (Separate for Illustration Purposes from the Hazard Signal Lights)

180 Wire(s) to Reverse Applicator

190 Reverse Applicator (Informative Purposes, Box with the Letter ‘A’ in the Center)

200 Wire(s) to Reverse Lights

210 Reverse Lights (Informative Purposes, Represented by a Single Light Bulb)

220 Wire(s) to Hazard Applicator (Separate for Illustration Purposes from the Turn Signal Applicator)

230 Hazard Applicator (Informative Purposes, Represented by a Square Box with the Letter ‘A’ in the Center) (Separate for Illustration Purposes from the Turn Applicator)

240 Wire(s) to Hazard Lights (Separate for Illustration Purposes from the Wire's to the Turn Signal Lights)

250 Hazard Lights (Informative Purposes, Represented by a Single Light Bulb) (Separate for Illustration Purposes from the Turn Signal Lights)

260 Wire(s) to Proximity Sensor Lights

270 Proximity Sensor Lights (Informative Purposes, Represented by Two Light Bulbs)

280 Wire(s) to manual On/Off Switch

290 Manual On/Off Switch (Informative Purposes, Represented by a Switch)

300 Wire(s) to Speed Odometer

310 Speed Odometer (Informative Purposes, Represented by an Odometer. Active Odometer Necessary to Receive a Reading to Facilitate Proximity Given MPH.)

320 Wire(s) to Existing Power Supply

330 Existing Power Supply (Computer Power Source) (Informative Purposes, Represented by a Single Disposable Battery)

340 Wire(s) to Control Panel

350 Control Panel (Informative Purposes, Represented by a Square Box with the Letters ‘CP’ in the Center)

360 Wire(s) to Interior Information System

370 Interior Information System (Informative Purposes, Represented by a Square Box with a Light Bulb and a Sound Symbol)

380 Wire(s) to the Malfunction Signal

390 Malfunction Signal (Informative Purposes, Represented by a Square Box with the Letter ‘M’ in the Center)

400 Alternate Adaptation, Attachment of secondary device through a port (i e. trailer attachment)

410 Proximity Sensing Device Below Roof

420 Proximity Sensing Device Above Vehicle's 3^{rd} Brake Signal Light

430 Vehicle's 3^{rd} Brake Signal Light

440 Proximity Sensing Above Liesence Plate

450 Proximity Sensing Device Lower Part of Bumper

460 Tailgating Signal Lights

470 Turning/Hazard Signal Lights

480 Brake Signal Lights

490 Reverse Signal Lights

500 Licenses Plate

510 Rear View of Trailer

520 Proximity Sensing Device (Trailer)

530 Vertical Rear Light Cluster

540 Horizontal Rear Light Cluster

550 Lead Vehicle Equipped with the Safety Motion Detector for Vehicles

560 Sensing Signals sent over given Proximity

570 Response Feedback from Proximity Breaching Vehicle

580 Proximity Breaching Vehicle

590 Vehicle within other Vehicular Lane

600 Non Proximity Breaching Vehicle

### DESCRIPTION OF THE PREFERRED EMBODIMENT(S)

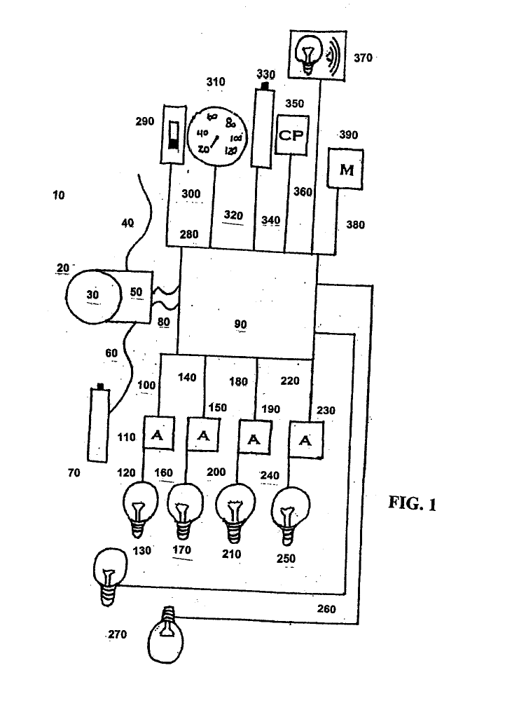

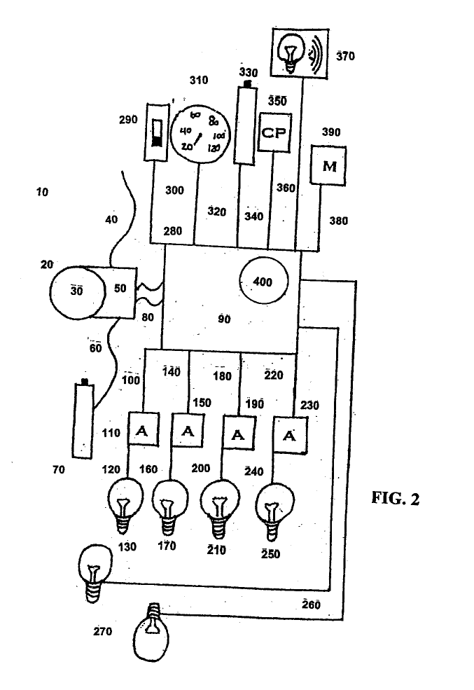

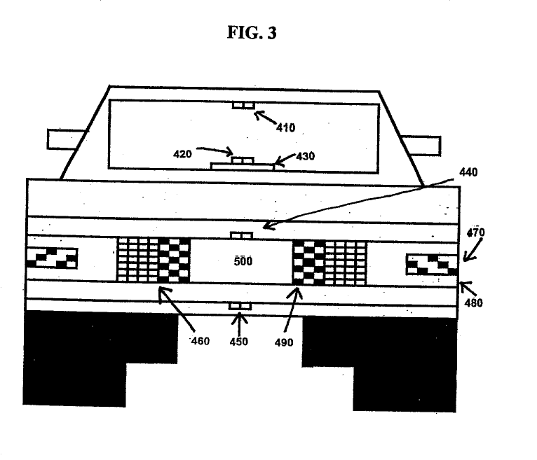

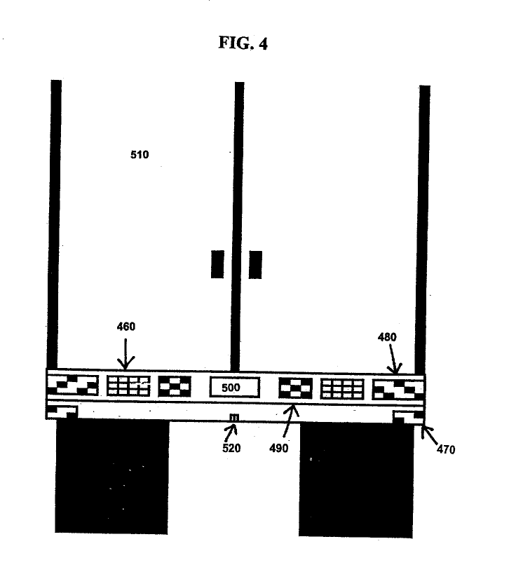

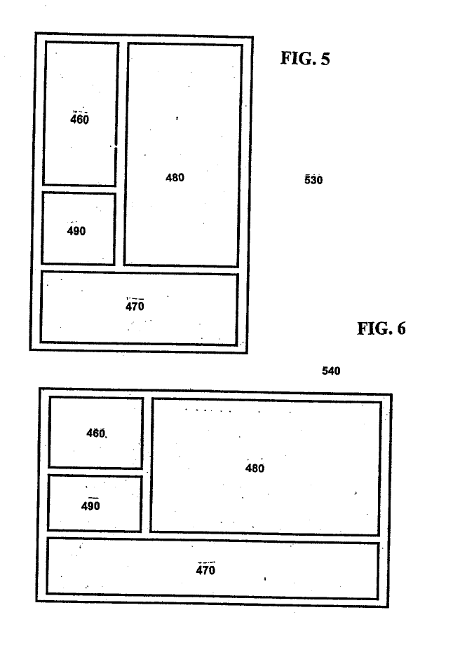

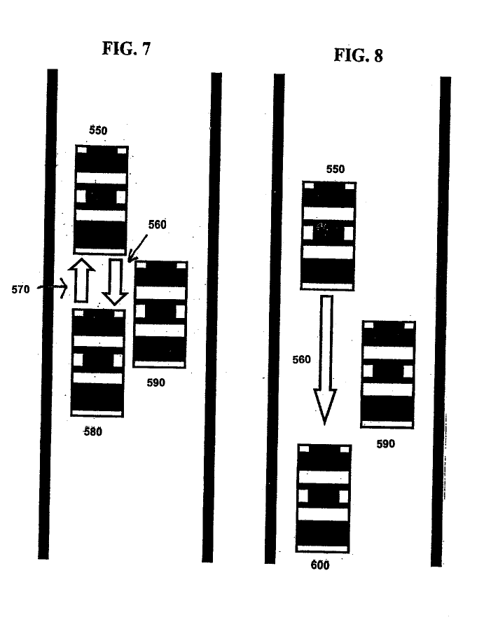

Turning now descriptively to the drawings, in which similar reference characters denote similar elements throughout the several views, FIGS. 1 and 2 illustrates the expanded view of the Safety Motion Detector for Vehicles 10. FIGS. 3 and 4 illustrates the rear of the vehicles. FIGS. 5 and 6 illustrates the vertical cluster 530 and the horizontal cluster 540. FIGS. 7 and 8 illustrates a proximity-sensing vehicle 580 and non-proximity-sensing vehicle 600.

Turning to FIG. 1, therein is an embodiment showing an expanded view of the Safety Motion Detector for Vehicles 10. Within this is a proximity container 20, housing a proximity-sensing device 30. This proximity container 20 connects to a ground wire 40, an existing power supply for the sensing device 70 through it's wires 60, and the vehicle's on board computer 90 through it's wires 80. The vehicle's on board computer 90 is connected to a brake applicator 110 through it's wires 100, turn signal applicator 150 through it's wires 140, reverse applicator 190 through it's wires 180, hazard applicator 240 through it's wires 230, proximity sensing lights 270 through it's wires 260, manual on/off switch 290 through its wires 280, a speed odometer 310 through it's wires 300, the vehicle's on board computer power supply 330 through it's wires 320, the device's control panel 350 through it's wires 340, the interior information center 370 through it's wires 360, and a malfunction signal 390 through it's wires 380. The brake applicator 110 is connected to it's signal light 130 through it's wire 120. The turn signal applicator 150 is connected to it's signal light 170 through it's wire 160. The reverse signal applicator 190 is connected to it's signal light 210 through it's wire 200. The hazard signal applicator 230 is connected to it's signal light 250 through it's wire 230.

Turning to FIG. 2, therein is an embodiment showing an expanded view of said Safety Motion Detector for Vehicles 10. Within this is a proximity container 20, housing a proximity-sensing device 30. This proximity container 20 connects to a ground wire 40, the existing power supply for the sensing device 70 through it's wires 60, and the vehicle's on board computer 90 through it's wires 80. The vehicle's on board computer 90 is connected to a brake applicator 110 through it's wires 100, turn signal applicator 150 through it's wires 140, reverse applicator 190 through it's wires 180, hazard applicator 240 through it's wires 230, proximity sensing lights 270 through it's wires 260, manual on/off switch 290 through its wires 280, a speed odometer 310 through it's wires 300, the vehicle's on board computer power supply 330 through it's wires 320, the device's control panel 350 through it's wires 340, the interior information center 370 through it's wires 360, a malfunction signal 390 through it's wires 380, and a adaptor port 400 built into the device's on board computer 90. The brake applicator 110 is connected to it's signal light 130 through it's wire 120. The turn signal applicator 150 is connected to it's signal light 170 through it's wire 160. The reverse signal applicator 190 is connected to it's signal light 210 through it's wire 200. The hazard signal applicator 230 is connected to it's signal light 250 through it's wire 230.

Turning to FIG. 3, therein is an embodiment showing a rear view of a vehicle containing four (4) possible placements of the proximity sensing container 20 and proximity sensing device 30. First, proximity sensing device below the roof 410. Second; proximity sensing device 420 above the 3^{rd} light 430. Third; proximity sensing device 440 above the licenses plate 500. Fourth; proximity sensing device on lower part of bumper 450. Also included in this FIG. 3 is the tailgating signal light 460, the turning/hazard signal light 470, the brake signal light, and the reverse signal light 490.

Turning to FIG. 4, therein is an embodiment showing a rear view the alternate vehicle (i.e. trailer) 510 containing a possible placement of the proximity-sensing device (trailer) 520 above the licenses plate 500. Also included in this FIG. 4 are the tailgating signal light 460, the turning/hazard signal light 470, the brake signal light, and the reverse signal light 490.

Turning to FIG. 5, therein is an embodiment showing a vertical rear view of the light cluster 530. Also included in this FIG. 5 is the tailgating signal light 460, the turning/hazard signal light 470, the brake signal light, and the reverse signal light 490.

Turning to FIG. 6, therein is an embodiment showing a horizontal rear view of the light cluster 540. Also included in this FIG. 6 are the tailgating signal light 460, the turning/hazard signal light 470, the brake signal light, and the reverse signal light 490.

Turning to FIG. 7, therein is an embodiment showing the lead vehicle equipped with the Safety Motion Detector for Vehicles 550. Following the lead vehicle 550 is the proximity-breaching vehicle 580. This breaching is represented as sensing signals sent over given proximity 560 and response feedback from proximity breaching vehicle 570. Also included in FIG. 7 is a vehicle within the other vehicular lane 590.

Turning to FIG. 8, therein is an embodiment showing the lead vehicle equipped with the Safety Motion Detector for Vehicles 550. Following the lead vehicle 550 is the non proximity-breaching vehicle 600. This non-breaching is represented as sensing signals sent over given proximity 560. Also included in FIG. 8 is a vehicle within the other vehicular lane 590.

Thus the reader will see that the Safety Motion Detector for Vehicles provides an effective, simple and useful way to communicate effectively. It is very economical compared to the increasing costs and fees associated with insurance. It is even a possibility than once this inventive device is patented, insurance companies will lower premiums on vehicles equipped with such devices as is the case with air bags and anti-lock brakes.

While my above descriptions contain much specificity, these should not be construed as limitation on the scope of the invention, but rather as an exemplification of one of the preferred embodiment(s) thereof Many other variations are possible. For example, the Safety Motion Detector for Vehicles could be in a variety of shapes, designs, colors, sizes, and materials utilized.

I claim:

1. A Safety Motion Detector for Vehicles comprising:
(a) a vehicle proximity sensing, range device,
(b) technologically advanced signaling means,
(c) enabling/disabling capabilities of device that will provide drivers with optional usage,
(d) rear signaling different from current brake light, vehicle/hazard, and or reverse signaling,
(e) said proximity based on various highway and road condition,
(f) enabling/disabling capabilities given parameters,
(g) warning based signal of system malfunctions and proximity breached situations,
whereby said Safety Motion Detector for Vehicles of said enabling/disabling capabilities of providing said optional usage, and
whereby said Safety Motion Detector for Vehicles of said brake light system will be deactivated during vehicle braking, and
whereby said Safety Motion Detector for Vehicles of said vehicle signaling light system will be deactivated during vehicle turning, and
whereby said Safety Motion Detector for Vehicles of said reverse vehicle signaling system will be deactivated during vehicle reversing, and
whereby said Safety Motion Detector for Vehicles of said hazard vehicle signaling system will be deactivated during vehicle hazard status, and
whereby said Safety Motion Detector for Vehicles of the device's on board computer system will activate/deactivate the attainment function of said on board computer.

2. Said Safety Motion Detector for Vehicles of claim 1, said proximity sensing device, and said technologically advanced signaling means will have a variety of colors, shapes, dimensions, materials utilized.

3. A Safety Motion Detector for Vehicles comprising:
(a) an alternate port for attachments,
(b) a proximity sensing, range device,
(c) technologically advanced signaling means,
(d) enabling/disabling capabilities of device that will provide drivers with optional usage,
(e) rear signaling different from current brake light, vehicle/hazard, and or reverse signaling,
(f) said proximity based on various highway and road condition,
(g) enabling/disabling capabilities given parameters,
(h) warning based signal of system malfunctions and proximity breached situations,
whereby said Safety Motion Detector for Vehicles contains said attachments to said vehicle, and
whereby said Safety Motion Detector for Vehicles of said enabling/disabling capabilities of providing said optional usage, and
whereby said Safety Motion Detector for Vehicles of said brake light system will be deactivated during vehicle braking, and
whereby said Safety Motion Detector for Vehicles of said vehicle signing light system will be deactivated during vehicle turning, and
whereby said Safety Motion Detector for Vehicles of said reverse vehicle signaling system will be deactivated during vehicle reversing, and
whereby said Safety Motion Detector for Vehicles of said hazard vehicle signaling system will be deactivated during vehicle hazard status, and
whereby said Safety Motion Detector for Vehicles of the device's on board computer system will activate/deactivate the attainment function of said on board computer.

4. Said Safety Motion Detector for Vehicles of claim 2, said proximity sensing device, and said technologically advanced signaling means will have a variety of colors, shapes, dimensions, materials utilized.
